(19) United States
(12) Patent Application Publication
(10) Pub. No.: US 2022/0373834 A1
(43) Pub. Date: Nov. 24, 2022

(54) APPARATUS AND METHOD FOR FORMING ELECTRODE OF DISPLAY PANEL

(71) Applicant: YL ENTERPRISE CO., LTD., Suwon-si, Gyeonggi-do (KR)

(72) Inventors: Gen Hyi HAN, Pyeongtaek-si, Gyeonggi-do (KR); Yong Chan JEONG, Pyeongtaek-si, Gyeonggi-do (KR); Jung Hyun HEO, Hwaseong-si , Gyeonggi-do (KR)

(21) Appl. No.: 17/773,178

(22) PCT Filed: Oct. 28, 2020
(86) PCT No.: PCT/KR2020/014807

§ 371 Date: Apr. 29, 2022

(30) Foreign Application Priority Data
Oct. 29, 2019 (KR) 10-2019-0135808

(51) Int. Cl. G02F 1/1343; G02F 1/13

(52) U.S. Cl. CPC G02F 1/13439; G02F 1/1309; G02F 1/1303

(57) ABSTRACT

Disclosed herein are a display panel electrode forming apparatus and method. A method of forming an electrode on at least one side surface of a display panel in a display panel electrode forming apparatus includes loading the display panel; and continuously moving the loaded display panel in a length direction of one side surface of the display panel without stopping, wherein, in the moving, a conductive paste is attached to the one side surface and hardened, and a portion of the hardened conductive paste is engraved to form a plurality of electrodes.

### TECHNICAL FIELD

The present invention relates to a display panel electrode forming apparatus and method.

### BACKGROUND ART

A display device is a device generating and displaying an image based on an electrical signal. In recent years, types of displays including a display panel such as a thin-film liquid crystal panel using a thin film transistor (TFT) as an essential component have been widely used. Through this, a thickness of display panels and devices has been innovatively decreased.

Another issue in display devices is a width of a bezel surrounding display panels. A display panel generally includes a plurality of electrodes for transmitting electrical signals to switching elements such as TFTs inside the display panel in an edge area thereof. Since the bezel accommodates the electrodes and connectors and wires connected thereto, there is a limitation in reducing the width thereof.

Accordingly, in order to eliminate the bezel or reduce the width of the bezel as described above, it is necessary to remarkably improve a method of forming the electrode. However, such improvement may involve problems to be addressed.

First, an operation of forming an electrode including a plurality of sub-processes may be a complicated and difficult operation. Accordingly, the cost and time required for the operation may be excessive and the yield thereof may also be lowered.

In addition, if precision is not guaranteed in the processing of the electrode, there is a limitation in increasing resolution of the display. Recently, a thin-film liquid crystal panel with UHD-class resolution is the trend in the market, so it is very important to secure enough processing precision to be applied to such a high-resolution panel.

### DISCLOSURE

### Technical Problem

An object of the present invention is to provide an electrode forming apparatus and method capable of forming an electrode on a side surface of a display panel, thereby significantly reducing a width of a bezel at an edge of the panel.

Another object of the present invention is to reduce a size of an electrode forming apparatus and increase the yield by simplifying a process of forming an electrode on a side surface of a display panel.

Another object of the present invention is to provide a unit for manufacturing a high-resolution display panel by improving processing precision of an electrode formed on a side surface of a display panel.

### Technical Solution

According to an exemplary embodiment of the present invention, a method of forming an electrode on at least one side surface of a display panel in a display panel electrode forming apparatus includes: loading the display panel; and continuously moving the loaded display panel in a length direction of one side surface of the display panel without stopping, wherein, in the moving, a conductive paste is attached to the one side surface and hardened, and a portion of the hardened conductive paste is engraved to form a plurality of electrodes.

In addition, the moving may include spraying and attaching the conductive paste to at least a portion of the one side surface; hardening the attached conductive paste using a first light; and removing a portion of the hardened conductive paste through an engraving operation using a second light.

In addition, the moving may further include re-hardening the conductive paste remaining after the portion is removed through the engraving operation using a third light.

Also, the moving may further include determining whether the plurality of formed electrodes satisfy a predetermined inspection criterion.

In addition, the determining may include determining whether the plurality of electrodes satisfy the predetermined inspection criterion through data analysis of an image of the plurality of formed electrodes obtained with at least one camera.

Also, the method may further include: returning the display panel to a starting position of the moving when the plurality of formed electrodes satisfy the predetermined inspection criterion, wherein the returning includes rotating the display panel to form an electrode on another side surface vertically adjacent to the one side surface.

In addition, the second light may be a laser, and the plurality of electrodes may include a plurality of rectangular electrodes arranged in a line in the length direction.

The moving may include moving the display panel at a constant velocity in the length direction of the one side surface.

According to another exemplary embodiment of the present invention, a method of forming an electrode on at least one side surface of a display panel in a display panel electrode forming apparatus includes: loading the display panel; spraying and attaching a conductive paste to at least a portion of one side surface of the loaded display panel; hardening the attached conductive paste using a first light; and removing a portion of the hardened conductive paste through an engraving operation using a second light, wherein at least one of the attaching, hardening, and removing is performed while the loaded display panel is continuously moved without stopping in a length direction of the one side surface of the display panel.

The moving may further include determining whether a plurality of formed electrodes satisfy a predetermined inspection criterion.

In addition, the method may further include: returning the display panel to a starting position of the moving when the plurality of formed electrodes satisfy the predetermined inspection criterion, wherein the returning includes rotating the display panel to form an electrode on another side surface of the display panel vertically adjacent to the one side surface.

The moving may include moving the display panel at a constant velocity in the length direction of the one side surface.

According to another exemplary embodiment of the present invention, a method of forming an electrode on at least one side surface of one display panel in a display panel electrode forming apparatus includes: loading the one display panel; spraying and attaching a conductive paste to at least a portion of one side surface of the one loaded display panel; hardening the attached conductive paste using a first light; and removing a portion of the hardened conductive paste through an engraving operation using a second light, wherein at least some of time intervals during which each of at least two of the attaching operation, hardening operation, and removing operation overlap each other.

In addition, at least two operations may be performed while the loaded display panel is continuously moved without stopping in a length direction of the one side surface of the display panel.

In addition, the at least two operations may be performed while the display panel is moved at a constant velocity in the length direction of the one side surface.

The method may further include determining whether the plurality of formed electrodes satisfy a predetermined inspection criterion.

The method may further include: returning the display panel to a starting position of the moving when the plurality of formed electrodes satisfy the predetermined inspection criterion, wherein the returning includes rotating the display panel to form an electrode on another side surface of the display panel vertically adjacent to the one side surface.

According to another exemplary embodiment of the present invention, a display panel electrode forming apparatus includes: a driving unit configured to load and move a display panel; a spray unit configured to spray conductive paste; a first photo-hardening unit configured to radiate a first light; an engraving unit configured to radiate a second light; and a controller configured to form a plurality of electrodes on one side surface of the display panel by controlling the driving unit, the spray unit, the first photo-hardening unit, and the engraving unit, wherein the controller forms the plurality of electrodes by controlling the spray unit to continuously spray the conductive paste and attach to at least a portion of the one side surface, controlling the first photo-hardening unit to radiate the first light to harden the continuously sprayed conductive paste, and controlling the engraving unit to radiate the second light to remove a portion of the cured conductive paste through an engraving operation, while controlling the driving unit so that the loaded display panel is continuously moved in a length direction of the one side surface of the display panel, without stopping.

The display panel electrode forming apparatus may further include: a first inspection unit configured to form inspection data of the electrode, wherein, while controlling the driving unit so that the loaded display panel is continuously moved in the length direction of one side surface of the display panel, without stopping, the controller may control the first inspection unit to form inspection data of the plurality of formed electrodes and may determine whether the plurality of formed electrodes satisfy a predetermined inspection criterion by analyzing the inspection data.

The first inspection unit may include at least one camera to form image data of the plurality of formed electrodes, and the controller determines whether the plurality of formed electrodes satisfy a predetermined inspection criterion by analyzing the image data.

In addition, the display panel electrode forming apparatus may further include: an aligning unit configured to align a position and posture of the display panel before the spray unit sprays the conductive paste; a cleaning unit configured to clean the one side surface before the conductive paste is sprayed from the spray unit, while the aligned display panel is continuously moving in the length direction of the one side surface of the display panel; and a second inspection unit configured to acquire thickness information of the cured conductive paste.

In addition, the controller may control the driving unit so that the loaded display panel is moved at a constant velocity, while continuously moving in the length direction, without stopping.

Also, the display panel electrode forming apparatus may further include: an aligning unit configured to align a position and a posture of the display panel before the loaded display panel is moved, wherein, when the plurality of formed electrodes satisfy a predetermined inspection criterion, the controller may control the driving unit to rotate the display panel to form an electrode on another side surface of the display panel vertically adjacent to the one side surface.

The second light may be a laser, and the plurality of electrodes may include a plurality of rectangular electrodes arranged in a line in the length direction.

Meanwhile, a computer program for performing the display panel electrode forming method may be distributed by a distribution server.

### Advantageous Effects

According to the various exemplary embodiments of the present invention described above, a width of a bezel at the edge of a panel may be significantly reduced by forming electrodes on a side surface of the display panel.

In addition, according to various exemplary embodiments of the present invention, while the display panel moves once, the processes of forming the electrode on the side surface of the display panel may be performed, thereby simplifying the process, reducing a size of an electrode forming apparatus, and increasing the manufacturing yield of the display panel.

Furthermore, according to various exemplary embodiments of the present invention, a high-resolution display panel may be manufactured by improving processing precision of the electrode formed on the side surface of the display panel.

### DESCRIPTION OF DRAWINGS

FIGS. 1A to 1C are views illustrating a side electrode of a display panel according to an exemplary embodiment of the present invention.

FIG. 2 is a block diagram illustrating a configuration of a display panel electrode forming apparatus according to an exemplary embodiment of the present invention.

FIGS. 3A and 3B are external views of a display panel electrode forming apparatus according to an exemplary embodiment of the present invention.

FIGS. 4A and 4B are views illustrating a shape of an electrode according to an exemplary embodiment of the present invention.

FIGS. 5A and 5B are views illustrating a shape of an electrode according to an exemplary embodiment of the present invention.

FIG. 6 is a view illustrating each major component of a display panel electrode forming apparatus according to an exemplary embodiment of the present invention.

FIG. 7 is a view illustrating an operation of a display panel electrode forming apparatus according to an exemplary embodiment of the present invention.

FIG. 8 is a flowchart illustrating a display panel electrode forming method according to an exemplary embodiment of the present invention.

FIG. 9 is a flowchart illustrating a display panel electrode forming method according to an exemplary embodiment of the present invention.

FIG. 10 is a flowchart illustrating a display panel electrode forming method according to an exemplary embodiment of the present invention.

### BEST MODE

The following only illustrate the principle of the present invention. Therefore, although not clearly described or shown in the specification, a person skilled in the art may invent various devices that implement the principle of the present invention and are included in the concept and scope of the present invention. Also, all conditional terms and exemplary embodiments enumerated in the specification are, in principle, intended only for the purpose of understanding the concept of the present invention and thus it should be understood that the present invention is not limited to exemplary embodiments and state to be particularly enumerated.

Also, it should be understood that all detailed descriptions enumerating specific exemplary embodiments as well as the principle, view and exemplary embodiments of the present invention are intended to include their structural and functional equivalents. Also, such equivalents should be understood as including currently known equivalents as well as equivalents to be developed in future, namely, all elements invented to perform the same function irrespective of their structures.

Thus, for example, block diagrams used herein should be understood as representing the concept of an exemplary circuit that embodies the principle of the present invention. Likewise, all flow charts, state transition diagrams, and pseudo codes should be understood as representing various processes that may be substantially represented on computer readable mediums and are performed by computers or processors irrespective of whether the computers or the processors are clearly shown.

The functions of various elements shown in drawings including a processor or a functional block represented as a concept similar to the processor may be provided by using dedicated hardware and hardware having an ability to execute software in terms of appropriate software. When being provided by a processor, such functions may be provided by a single dedicated processor, a single shared processor, or a plurality of individual processors of which some may be shared.

Also, the clear usage of a processor, control or a term presented as concept similar to those described in the detailed description should not be interpreted as exclusive citation of hardware having an ability to execute software, but be understood as implicitly including a digital signal processor (DSP) hardware, a ROM for storing software, a RAM, and a non-volatile memory without limitation. Other known and common hardware may also be included.

In the following claims, components expressed as means for performing functions described in the detailed description are intended as including, for example, combinations of circuit elements performing the functions or all methods performing functions including all types of software including firmware/micro codes, and are combined with appropriate circuits for executing the software to perform the functions. Since the present invention defined by such claims follows a rule needed by claims and functions provided by various enumerated means are combined, it should be understood that any means capable of providing the functions are equivalent to matters grasped from the specification.

The above objects, characteristics, and advantages will be clear through the following detailed description related to the accompanying drawings and thus a person skilled in the art will be able to easily practice the technological spirit of the present invention. When describing the present invention, detailed descriptions related to well-known functions or configurations will be ruled out in order not to unnecessarily obscure subject matters of the present invention.

Exemplary embodiments are described below in more detail with reference to the accompanying drawings.

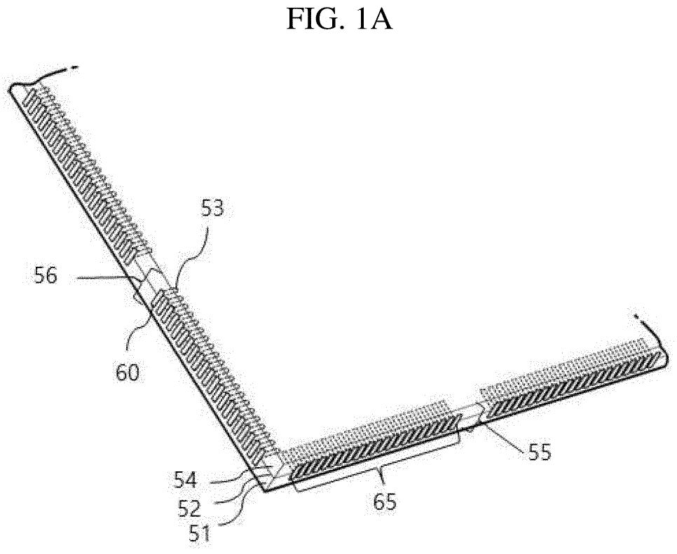

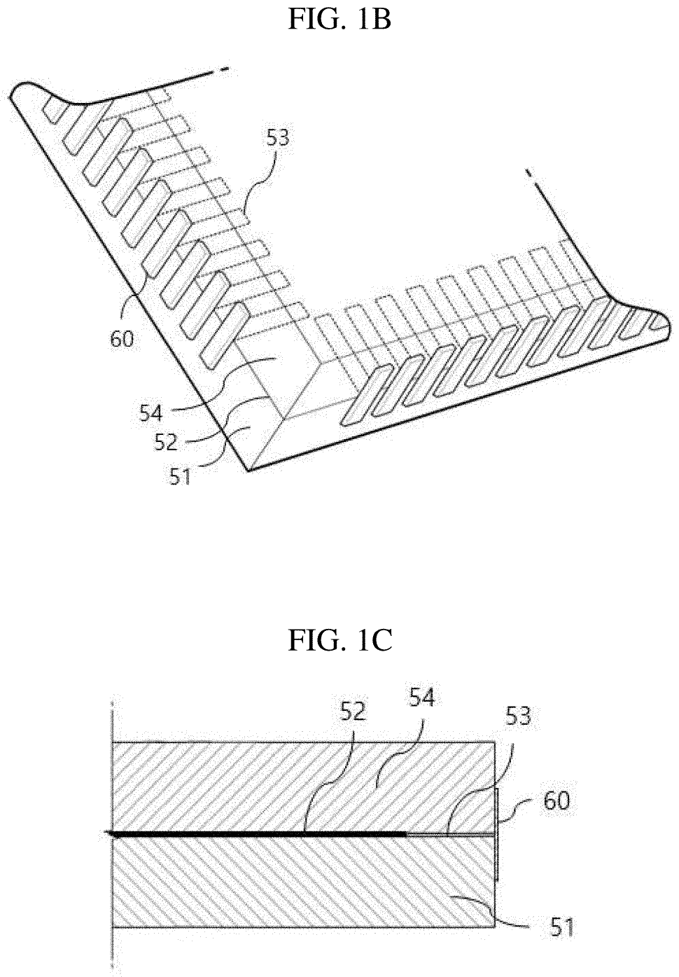

FIGS. 1A to 1C are views illustrating a side electrode of a display panel according to an exemplary embodiment of the present invention. More specifically, FIG. 1A is a perspective view showing a portion of a display panel 50, and FIG. 1B is an enlarged view of a portion of FIG. 1A. FIG. 1C is a cross-sectional view of the display panel 50 in one direction.

As shown in FIGS. 1A to 1C, an electrode 60 is formed on a side surface of a display panel 50 according to an exemplary embodiment of the present invention.

The electrode 60 transmits an electric signal supplied from the outside to a wiring layer 52 of the display panel 50. The wiring layer 52 may be configured to apply a voltage or current corresponding to the electrical signal to display an image on the display panel 50.

When the display panel 50 is a device that displays an image by controlling light in units of a plurality of sub-pixels, the wiring layer 52 may include switching elements disposed to correspond to the pixels, respectively, to adjust light as described above by applying or cutting off a voltage or a current.

In the display panel according to an exemplary embodiment of the present invention, a liquid crystal layer (not shown) may be attached between an array substrate 51 and a color filter substrate 54. In the present exemplary embodiment, the array substrate 51 may include the wiring layer 52.

A plurality of electrodes 60 of the present invention may be formed on the side surface of the display panel 50.

Preferably, the display panel 50 may be configured in the form of a rectangular panel having a predetermined thickness.

The electrodes 60 may be formed on each of the two adjacent side surfaces 55 and 56 of the rectangular display panel 50.

The wiring layer 52 may include a lead 53 corresponding to and connected to the electrode 60 to transmit the voltage or current to the switching elements.

As shown in FIG. 1A, the electrode 60 and the lead 53 may be formed in groups in units of tabs 65. There may be a section in which the electrode 60 or the lead 53 is not formed by a predetermined length between the tab 65 and the tab 65.

According to an exemplary embodiment of the present invention, the display panel 50 may be a panel of a liquid crystal display (LCD).

In addition, the display panel 50 may be a panel of a thin-film-transistor liquid crystal display (TFT LCD). In this case, the switching element may be a TFT.

However, the display panel 50 of the present invention is not limited to the above example and may include receiving an electrical signal through a side surface, as an electrical signal-image conversion device implemented in a panel shape.

As described above, since the electrode 60 is formed on the side surface of the display panel 50, a portion in which an image is not displayed on the edge of the display panel 50 may be eliminated or minimized, compared to a case in which the electrode 60 is formed in the wiring layer 52. Through this, it is possible to eliminate the bezel of the display panel 50 or minimize a thickness thereof.

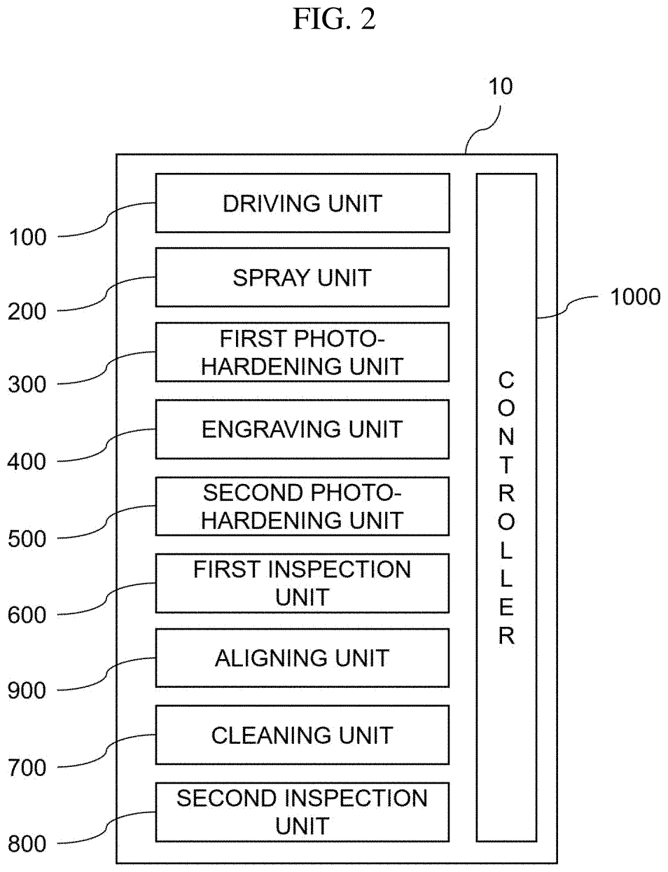

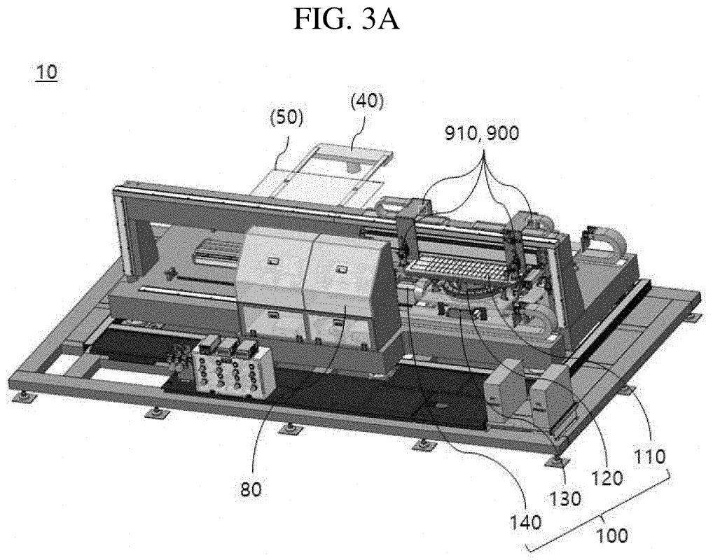

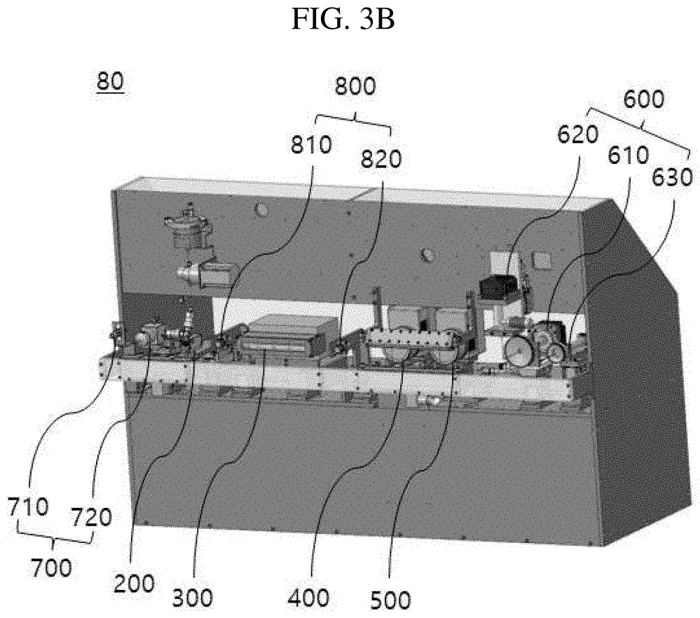

FIG. 2 is a block diagram illustrating a configuration of a display panel electrode forming apparatus according to an exemplary embodiment of the present invention. Also, FIGS. 3A and 3B are external views of a display panel electrode forming apparatus according to an exemplary embodiment of the present invention.

As shown in FIGS. 2, 3A and 3B, a display panel electrode forming apparatus 10 according to an exemplary embodiment of the present invention may include a driving unit 100, a spray unit 200, a first photo-hardening unit 300, and an engraving unit 400.

The display panel electrode forming apparatus 10 may further include a second photo-hardening unit 500.

The driving unit 100 may be a component in which the display panel 50 drawn in from the outside of the apparatus 10 is loaded and moved.

According to an exemplary embodiment of the present invention, the driving unit 100 may include a plate 110 on which the display panel 50 is loaded.

At least one hole may be formed in a surface of the plate 110. Preferably, a plurality of micro holes may be distributed throughout the surface. A fluid such as air may be intaken or discharged through the hole.

When an intaking operation takes place through the hole while the display panel 50 is in contact with the surface, the display panel 50 is fixed in close contact with the surface. In this state, the display panel 50 may be stably moved according to the movement of the plate 110.

When the intaking operation is stopped through the hole while the display panel 50 is in contact with the surface, preferably, when a discharge operation takes place, the display panel 50 may be easily detached from the surface. After the process according to the present invention is completed, such a state may be created immediately before discharging the display panel 50 to the outside of the apparatus 10.

According to an exemplary embodiment of the present invention, a surface of the plate 110 is preferably formed to be parallel to a floor surface on which the apparatus 10 is installed. In such a state, the display panel 50 may be stably supported in parallel with a direction of gravity.

The plate 110 may be supported and rotated by a rotating unit 120. According to an exemplary embodiment of the present invention, the rotating unit 120 may rotate in a specific rotation direction about a rotation axis in a direction perpendicular to the floor surface. In addition, after rotation, the rotating unit 120 may rotate in the opposite direction to return to the original position.

The rotating unit 120 may perform an operation of rotating the display panel 50 to form an electrode on another side surface 56, after the electrode 60 is formed on the one side surface 55 of the display panel 50. Also, the rotating unit 120 may be a unit for in-place alignment of the display panel 50.

The rotating unit 120 may include a rotating motor (not shown). According to an exemplary embodiment, the rotating unit 120 may be driven in a direct driving manner as a rotor of the rotating motor (not shown) and the plate 110 are directly connected. In this case, the rotating motor (not shown) may be a direct driving (DD) motor.

In another exemplary embodiment, the rotating unit 120 may include a separate power transmission unit (not shown) transmitting power from the rotating motor (not shown) to the plate 110. The power transmission unit (not shown) may be a gear box (not shown) or a pulley-belt (not shown).

The driving unit 100 may include a first linear actuator 130 for linearly moving the plate 110.

Preferably, the first linear actuator 130 preferably moves the plate 110 and the rotating unit 120 in a direction parallel to the floor surface.

After the display panel 50 is drawn in from the outside of the apparatus 10 and loaded in the plate 110, the first linear actuator 130 may perform an operation of moving the display panel 50 to positions in which each process based on the electrode forming method of the present invention to be described later is performed. Also, the first linear actuator 130 may be a unit for aligning the display panel to a regular position. According to an exemplary embodiment of the present invention, the first linear actuator 130 may be implemented as a linear motor. However, besides, any actuator that may be able to transfer in a linear direction may also be applied.

In the present disclosure, for convenience, an operating direction of the first linear actuator 130 may be considered as a y-axis, and the first linear actuator 130 may be referred to as a Y-axis linear actuator.

The driving unit 100 may include a second linear actuator 140 moving the plate 110 while each process of the electrode forming method of the present invention, which will be described later, is performed. The second linear actuator 140 may also be a unit for in-place alignment of the display panel 50.

Preferably, the second linear actuator 140 moves the plate 110, the rotating unit 120, and the first linear actuator 130 in a direction parallel to the floor surface.

According to an exemplary embodiment, an operating direction of the first linear actuator 130 and an operating direction of the second linear actuator 140 may be perpendicular.

In the present disclosure, for convenience, an operating direction of the second linear actuator 140 may be considered as an x-axis, and the second linear actuator 140 may be referred to as an X-axis linear actuator.

The spray unit 200 may be configured to spray a conductive paste 70. The conductive paste 70 may include a conductive material such as metal. The conductive material may be preferably silver (Ag).

The conductive paste 70 has the conductive material dissolved in a solvent, may have a viscosity capable of maintaining a state attached to a specific surface for a certain period of time or longer, may be sprayed, and may be hardened by energy such as infrared light, ultraviolet light, or laser to be switched to a phase that may be converted into a solid state that may be energized.

The first photo-hardening unit 300 may emit a first light. The first light may be light for hardening the conductive paste 70 by transferring energy to the conductive paste 70. The first light is preferably infrared, ultraviolet or laser. More preferably, the first light is a laser.

According to an exemplary embodiment of the present invention, the hardening by the first light may be an operation including at least one of “sintering”, “hardening” and “drying”.

The “sintering” may be an operation in which particles are melted to be adhered to each other and solidified through heating. When the first light is a laser, the “sintering” operation may be easily implemented.

The “hardening” may be an operation of generating a material having a high molecular weight from a unit by a chemical bonding reaction.

The “drying” may refer to an operation of hardening by removing moisture or solvent substances.

When hardening by the first light is a polymerization or drying operation, the first light may be infrared or ultraviolet light.

When the first light is infrared light, hardening by the first light may be thermal hardening.

When the first light is ultraviolet light, hardening by the first light may be photo-hardening.

The hardening by the first light may be any one of “sintering”, “hardening”, and “drying”. Also, in another exemplary embodiment, at least two of them may be sequentially or simultaneously performed.

The engraving unit 400 may emit a second light. The second light may transfer energy to the conductive paste 70 to remove a portion of the conductive paste 70 through an engraving operation. The second light is preferably a laser.

In an exemplary embodiment including the second photo-hardening unit 500, the second photo-hardening unit 500 may emit a third light. The third light may be light for re-hardening the conductive paste 70 by transferring energy to the conductive paste 70.

The hardening by the third light may be sintering. In this case, the third light is preferably a laser.

When the hardening by the first light is “polymerization” or “drying”, the apparatus 10 preferably includes the second photo-hardening unit 500 to perform “sintering” by the third light. With this configuration, a portion of the conductive paste 70 in a soft state from which moisture has been removed through “polymerization” or “drying” may be easily removed through the engraving operation of the second light, and the remaining portion of the conductive paste 70 may be tightly sintered through the third light.

According to an exemplary embodiment of the present invention, the apparatus 10 may further include a controller 1000. The controller 1000 may be physically formed at a position adjacent to other components of the present invention or may be formed at a remote position to control operations of other components through wired or wireless communication.

The controller 1000 may control the driving unit 100, the spray unit 200, the first photo-hardening unit 300, the engraving unit 400, and the second photo-hardening unit 500 to form a plurality of electrodes 60 on one side surface of the display panel 50.

The controller 1000 may control the driving unit 100 so that the loaded display panel 50 continuously moves in the length direction of one side surface of the display panel 50, without stopping.

The controller 1000 may control the spray unit 200 to spray and attach the conductive paste 70 to at least a portion of the one side surface.

As described above, precise workability may be secured even on an irregular surface through a jetting method of jetting the conductive paste 70.

The spray unit 200 may continuously spray the conductive paste 70 from a starting position of the electrode 60 to an ending position of the electrode 60, while the loaded display panel 50 continuously moves, without stopping, in the length direction of one side surface of the display panel 50.

Alternatively, in another exemplary embodiment, the conductive paste 70 may be sprayed in units of the tabs 65. That is, spraying may not be performed in an empty section between the tabs 65. In this exemplary embodiment, the conductive paste 70 may be saved, and it is possible to minimize the particleization of the conductive paste 70 cut out in an engraving process to be described later and flying.

The controller 1000 may control the first photo-hardening unit 300 to harden the sprayed conductive paste 70 by emitting the first light.

The controller 1000 may control the engraving unit 400 to emit the second light to remove a portion of the hardened conductive paste 70 that does not correspond to the plurality of electrodes 60 through an engraving operation.

The controller 1000 may control the second photo-hardening unit 500 to re-harden the conductive paste 70 remaining after the portion has been removed through the engraving operation by using the third light.

During the engraving, the conductive paste 70 may be blown as powder. In order to remove such powder, the apparatus 10 may further include a particle removal unit (not shown). Such a particle removal unit (not shown) preferably includes a vacuum suction unit (not shown). More preferably, the particle removal unit includes an air spray unit (not shown) on one side and a vacuum suction unit (not shown) for sucking the sprayed air on the other side. The air spray unit (not shown) may be a unit for spraying air in the form of an air curtain through a slit or a nozzle.

As described above, the controller 1000 may form the plurality of electrodes 60 by controlling the spray unit 200, the first photo-hardening unit 300, the engraving unit 400, and the second photo-hardening unit 500 described above.

The controller 1000 may control at least one of the operations of the spray unit 200, the first photo-hardening unit 300, the engraving unit 400, and the second photo-hardening unit 500 for forming the electrode 60 as described above, while the loaded display panel 50 continuously moves, without stopping, in the length direction of one side surface of the display panel 50.

In this manner, by allowing the display panel 50 to move during the process, a phenomenon in which the control for performing the process and the position control interfere with each other may be minimized, compared to a case in which the process is performed, while the spray unit 200, the first photo-hardening unit 300, the engraving unit 400, the second photo-hardening unit 500, etc. are moved.

The controller 1000 may control all the operations of the spray unit 200, the first photo-hardening unit 300, the engraving unit 400, and the second photo-hardening unit 500 for forming the electrode 60 as described above to be performed, while the loaded display panel 50 continuously moves without stopping in the length direction of the one side surface of the display panel 50.

The controller 1000 may control at least two of the operations of the spray unit 200, the first photo-hardening unit 300, the engraving unit 400, and the second photo-hardening unit 500 for forming the electrode 60 as described above to be performed simultaneously on the one display panel 50.

The controller 1000 may control at least one of the operations of the spray unit 200, the first photo-hardening unit 300, the engraving unit 400, and the second photo-hardening unit 500 for forming the electrode 60 as described above to be performed, while the loaded display panel 50 to be continuously moved without stopping in the length direction of the one side surface of the display panel 50.

When devices for each process are separately provided, it is necessary to insert, discharge, and move the panel 50 one by one by a scara robot or the like for the progress of the process. Accordingly, the size of the entire apparatus may increase, cost may increase, and the yield may decrease. Also, when a defect occurs, it is difficult to immediately rework it.

However, in the apparatus 10 of the present invention, by performing all processes necessary for electrode formation in one apparatus 10, while the panel 50 is moved, as described above, such unnecessary work as described above may be eliminated.

The display panel electrode forming apparatus 10 according to an exemplary embodiment of the present invention may further include a first inspection unit 600 forming inspection data of the electrode 60.

The controller 1000 may control the first inspection unit 600 to form inspection data of the plurality of formed electrodes 60, while controlling the driving unit 100 so that the loaded display panel 50 moves continuously in the length direction of one side surface of the display panel 50 without stopping. Furthermore, by analyzing the inspection data, it may be determined whether the plurality of formed electrodes 60 satisfy a predetermined inspection criterion. This determination operation may also be performed simultaneously, while controlling the driving unit 100 so that the loaded display panel 50 moves continuously in the length direction of one side surface of the display panel 50 without stopping.

The first inspection unit 600 may include at least one first camera 610. The first camera 610 may form image data of the plurality of formed electrodes 60. The controller 1000 may analyze the formed image data to determine whether the plurality of formed electrodes 60 satisfy a predetermined inspection criterion.

The first inspection unit 600 may further include a 1-1 camera 620. In addition, the first inspection unit 600 may further include a 1-2 camera 620. According to an exemplary embodiment of the present invention, the first camera 610 may be a line scan camera. Preferably, one side surface of the panel 50 may be scanned. In order to check the image of the electrode 60 on the side surface of the panel 50 and the lead 53 on an upper surface of the panel 50, upper surface and side surface inspection images may be obtained using the line scan camera, while the panel 50 moves at a constant velocity.

Such inspection criterion will be described in detail with reference to the drawings.

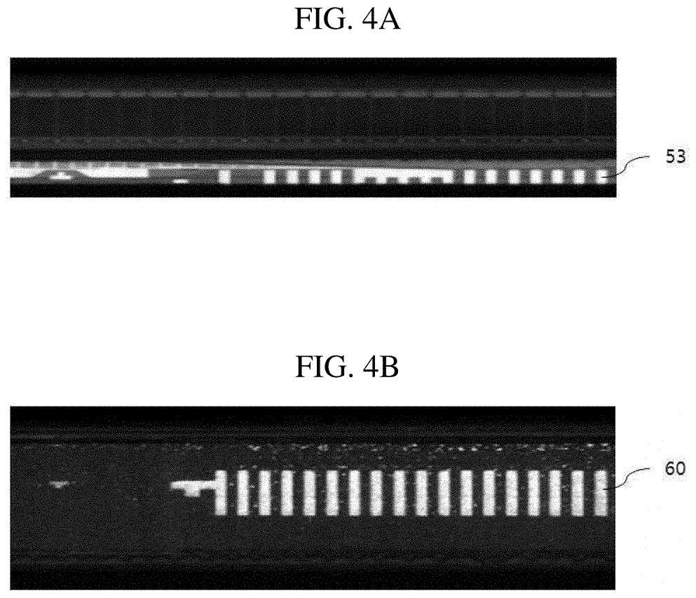

FIGS. 4A and 4B are views illustrating a shape of an electrode according to an exemplary embodiment of the present invention. More specifically, FIG. 4B shows an example of an image captured by the first camera 610 in a state in which the electrode 60 of the present invention is normally formed. The portion shown in white in FIG. 4B may correspond to the electrode 60.

The 1-1 camera 620 may be a line scan camera. Preferably, the upper surface of the panel 50 may be scanned.

FIG. 4A shows an example of an image captured by the 1-1 camera 620 in a state in which the lead 53 of the wiring layer 52 of the present invention is formed. The white color at the bottom of FIG. 4A may indicate the lead 53.

The 1-2 camera 630 may be an area camera. By photographing an area, it is possible to review an attachment state of the electrode with the naked eye or the like.

As can be seen in FIGS. 4A and 4B, the electrode 60 is preferably aligned so that its position corresponds to each position of the lead 53. As can be seen in FIG. 4B, it is preferable that the shape of the electrodes 60 is uniform and arranged at regular intervals.

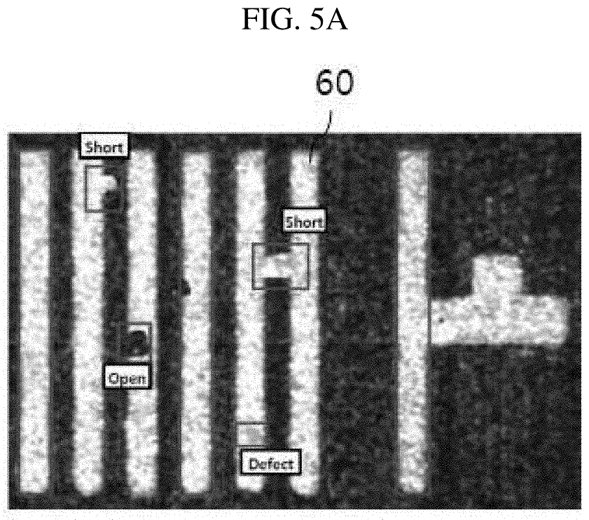

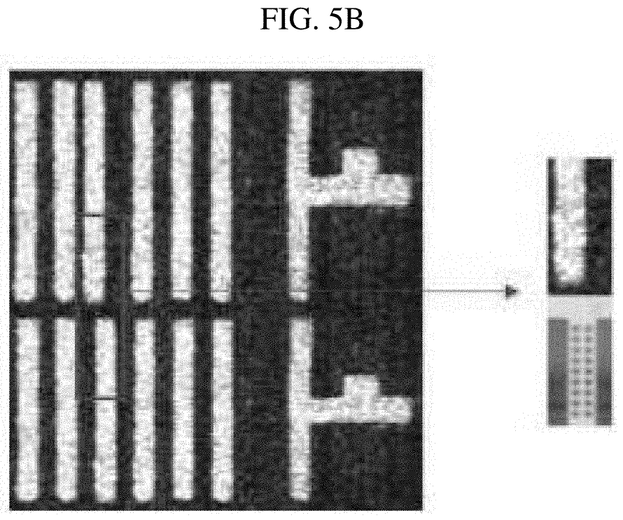

FIGS. 5A and 5B are views illustrating a shape of an electrode according to an exemplary embodiment of the present invention. More specifically, FIGS. 5A and 5B are examples of images obtained by photographing electrodes in an abnormal state that do not satisfy the predetermined inspection criterion.

One of the predetermined inspection criteria may be a case in which the electrode 60 is not accurately formed in a predetermined pattern (shape). More specifically, such an inspection criterion may be divided into an inspection criterion for determining an abnormal state when the conductive paste 70 remains in an area other than the predetermined pattern and an inspection criterion for determining an abnormal state when the conductive paste 70 does not completely fill the predetermined pattern.

If the former inspection criterion is not satisfied, a short circuit as shown in FIG. 5A may occur in an extreme case.

As such, when the former inspection criterion is not satisfied, it is preferable to engrave and remove the conductive paste 70 remaining in the area other than the pattern through rework. Alternatively, all the electrodes 60 included in a predetermined section (for example, the tab 65) including the abnormal electrode may be removed through an engraving operation, the process including spraying, hardening, and engraving may be repeated for the corresponding section.

If the latter inspection criterion is not met, an open may occur as shown in FIG. 5B. In extreme cases, some of the electrodes 60 may be omitted. In this case, an electric signal is not transmitted from the electrode 60 to the lead 53.

As such, when the latter inspection criterion is not satisfied, it is preferable to repeat, starting from the spraying operation again. In another exemplary embodiment, after the electrodes 60 included in a predetermined section (for example, the tab 65) including the abnormal electrode may be removed through an engraving operation, the process steps including spraying, hardening, and engraving may be repeated on the corresponding section to re-form the electrode 60.

Another predetermined inspection criterion is a case in which an impurity other than the conductive paste 70 is mixed in the electrode 60 to cause a defect, as shown in FIG. 5A. If such inspection criterion is not met, it is preferable to remove the electrodes 60 included in a predetermined section (for example, the tab 65) including the abnormal electrode through an engraving operation and then repeat the process including spraying, hardening, and engraving to re-form the electrode 60.

Another predetermined inspection criterion may be a criterion for determining an abnormality when a miss alignment occurs due to uneven spacing between adjacent electrodes 60, as shown in FIG. 5B. If such inspection criterion is not met, it is preferable to remove the electrodes 60 included in a predetermined section (for example, the tab 65) including the abnormal electrode through an engraving operation and then repeat the process including spraying, hardening, and engraving to re-form the electrode 60.

Another predetermined inspection criterion may be a criterion for determining an abnormality when a thickness of the electrode 60 is excessively thick or thin. If such inspection criterion is not met, it is preferable to remove the electrodes 60 included in a predetermined section (for example, the tab 65) including the abnormal electrode through an engraving operation and then repeat the process including spraying, hardening, and engraving to re-form the electrode 60.

When the plurality of formed electrodes 60 do not satisfy at least one of the predetermined inspection criteria, the controller 1000 may control the driving unit 100 to return the display panel 50 to a rework position corresponding to the at least one criterion.

The apparatus 10 according to an exemplary embodiment of the present invention may further include an aligning unit 900. The aligning unit 900 aligns a position and posture of the loaded display panel 50.

More specifically, after the display panel 50 is loaded on the plate 110, the aligning unit 900 aligns the position and posture of the display panel 50 at least before the conductive paste 70 is sprayed to form an electrode of the present invention after the display panel 50 is loaded in the plate 110.

By aligning the position and posture of the display panel 50 in this manner, a relative position and posture between the components such as the spray unit 200, the first photo-hardening unit 300, the engraving unit 400, the second photo-hardening unit 500, etc. and the display panel 50 become suitable for processes such as spraying, hardening, engraving, and sintering.

The aligning unit 900 may include at least one second camera 910. The controller 1000 may determine whether the position or posture is correct based on an image captured by the camera. In order to analyze the image, a specific mark may be formed at a specific position of the display panel 50.

In an exemplary embodiment of the present invention, the aligning unit may include at least one distance measuring sensor (not shown) in addition to the second camera 910. In this case, the position or posture of the display panel 50 may be pre-aligned using the second camera 910, and the position or posture may be aligned more accurately through the distance measuring sensor (not shown) or a combination of the distance measuring sensor (not shown) and the second camera 910. The distance measuring sensor (not shown) may measure a distance from the distance measuring sensor (not shown) to the one side surface of the display panel 50.

Preferably, two second cameras 910 and two distance measuring sensors (not shown) may be provided.

In another exemplary embodiment of the present invention, a plurality of second cameras 910 may be provided to align the position or posture of the display panel 50 in two steps (pre-align, align). That is, the position or posture of the display panel 50 may be pre-aligned through a camera capable of photographing a wide angle, and the position or posture may be more accurately aligned with a higher-resolution camera.

Preferably, four second cameras 910 may be provided. That is, the position and posture of the display panel 50 may be pre-aligned through two cameras capable of capturing a wide angle, and the position and posture may be aligned more accurately through two cameras with higher resolution. To this end, marks may be respectively formed at two specific positions of the display panel 50.

The aligning unit 900 may include an alignment operating unit for moving the display panel 50 and the position and posture under the control of the controller 1000 to align the display panel 50. The alignment operating unit may be implemented through a component performing other functions of the apparatus 10 of the present invention. In an exemplary embodiment, the alignment operating unit may be implemented as the driving unit 100. More specifically, the alignment operating unit may be implemented through the first linear actuator 130, the second linear actuator 140, and the rotating unit 120.

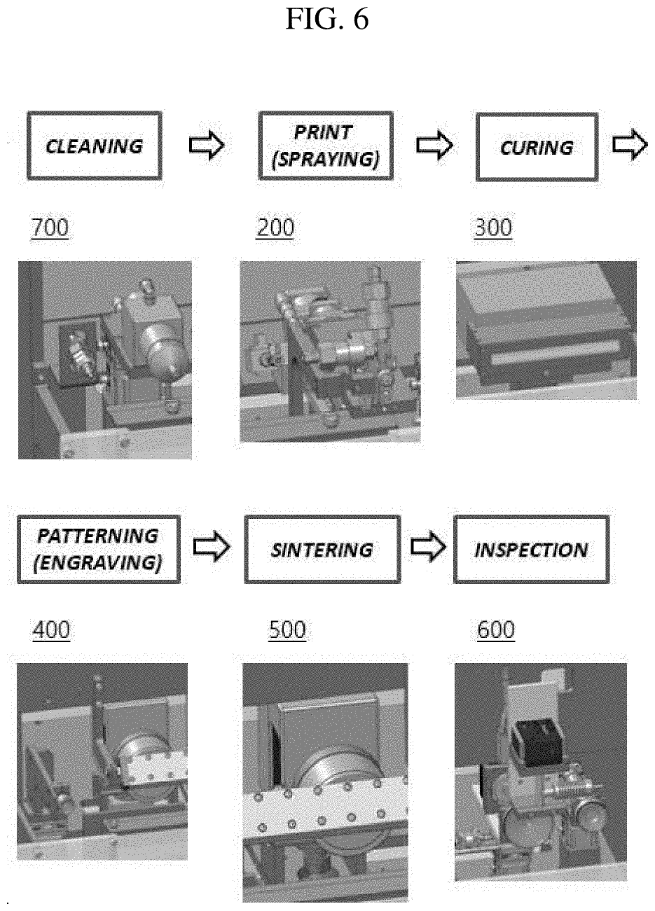

FIG. 6 is a view illustrating each major component of a display panel electrode forming apparatus according to an exemplary embodiment of the present invention.

As shown in FIG. 6, the apparatus 10 may include a spray unit 200, a first photo-hardening unit 300, an engraving unit 400, and a second photo-hardening unit 500, and besides, a cleaning unit 700 and a first inspection unit 600.

The apparatus 10 may further include the cleaning unit 700. While the display panel 50 is continuously moved in the length direction of one side surface of the display panel 50, the cleaning unit 700 may clean the one side surface before the conductive paste 70 is sprayed from the spray unit 200. By cleaning the one side surface in advance as described above, contamination may be prevented and the degree of adhesion of the conductive paste 70 and the quality of the electrode 60 may be improved.

The cleaning unit 700 may include at least one of an air blow nozzle 710 and a plasma nozzle 720. Preferably, the air blow nozzle 710 sprays air to first remove a contamination source attached to the one side surface, and the plasma nozzle 720 removes secondly.

According to an exemplary embodiment of the present invention, while the panel 50 moves at a constant velocity, foreign substances present on the side surface of the panel 50 may be removed using an air blow nozzle, surfaces of various substrates contaminated by organic substances may be dry-cleaned using atmospheric pressure plasma using only clean dry air (CDA), the uniformity of a material such as the conductive paste 70 to be coated may be improved by increasing surface energy, and adhesion in the case of bonding dissimilar materials may be improved.

The cleaning operation is preferably performed after the alignment operation of the display panel 50 is completed.

Also, the apparatus 10 may further include a second inspection unit 800 obtaining thickness information of the hardened conductive paste 70. By inspecting the thickness as described above, the conductivity and durability of the electrode 60 may be secured. When it is determined that a predetermined inspection criterion is not satisfied by analyzing the image data obtained by the second inspection unit 800, the controller 1000 may return the display panel 50 to the rework position as described above to perform rework.

The second inspection unit 800 may include at least one of a 2D displacement sensor and a 3D displacement sensor.

In an exemplary embodiment of the present invention, as shown in FIG. 3B, the second inspection unit 800 may include a first 2D displacement sensor 810 and a second 2D displacement sensor 820. The first 2D displacement sensor 810 may be located behind the spray unit 200. The second 2D displacement sensor 820 may be located behind the first photo-hardening unit 830.

When an analysis result of image data of at least some of the plurality of formed electrodes 60 obtained by the first inspection unit 600 and/or the second inspection unit 800 does not satisfy at least one of the predetermined inspection criteria, the controller 1000 may control the driving unit 100 to return the display panel 50 to the rework position in which a step corresponding to the at least one criterion may be performed.

The rework may be performed on one area including the at least some of the electrodes 60 in the entire area of the one side surface. The one area may be the tab 65.

The rework position may be at least one of positions corresponding to the cleaning, spraying, hardening, and engraving processes. More specifically, the rework position may include at least one of positions in which an operation of a component corresponding to the at least one criterion, among the aligning unit 900, the cleaning unit 700, the spray unit 200, the first photo-hardening unit 300, the engraving unit 400, and the second photo-hardening unit 500 is performed.

The predetermined inspection criterion may include a first criterion satisfied when the conductive paste 70 is not attached to an area except for the electrode 60 pattern in the entire area of the one side surface.

When the first criterion is not satisfied, the rework position may include a position in which the operation of the engraving unit 400 is performed.

The predetermined inspection criterion may include a second criterion satisfied when the conductive paste 70 is attached to the entirety of an area included in the electrode 60 pattern in the entire area of the one side surface.

When the second criterion is not satisfied, the rework position may include work positions of the spray unit 200, the first photo-hardening unit 300, and the engraving unit 400.

The predetermined inspection criterion may include a third criterion satisfied when the plurality of formed electrodes 60 are formed in a regular position according to the electrode 60 pattern.

When the third criterion is not satisfied, the rework position may include a position in which the operation of the spray unit 200, the hardening unit, and the engraving unit 400 is performed.

The controller 1000 may control the driving unit 100 so that the loaded display panel 50 moves at a constant velocity in the length direction, without stopping.

When the plurality of formed electrodes 60 satisfy a predetermined inspection criterion, the controller 1000 may return the display panel 50 to the work position of the cleaning unit 700 or the aligning unit 900.

When the plurality of formed electrodes 60 satisfy a predetermined inspection criterion, the controller 1000 may drive the driving unit 100 to rotate the display panel 50 to form an electrode on the other side surface of the display panel 50 vertically adjacent to the one side surface. That is, the controller 1000 may control driving unit 100 so that the other side surface comes to the position of the one side surface.

The second light may transfer energy to the conductive paste 70 to remove a portion of the conductive paste 70 through an engraving operation. The second light may be a laser.

The plurality of electrodes 60 may include a plurality of rectangular electrodes 61 that form a line in the length direction.

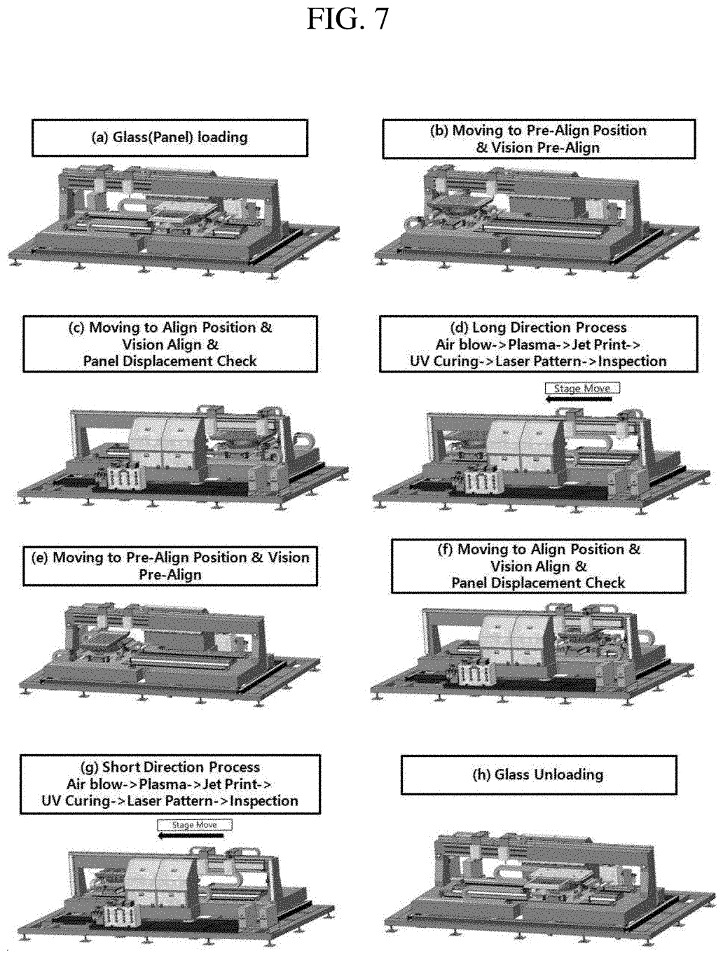

FIG. 7 is a view illustrating an operation of a display panel electrode forming apparatus according to an exemplary embodiment of the present invention.

As shown in FIG. 7, the apparatus 10 may load the display panel 50 (refer to FIG. 7(a)) in a state before the side electrode 60 is formed on the plate 110, move the panel 50 to a predetermined position to pre-align the panel 50 (refer to FIG. 7(b)), align the panel 50 (refer to FIG. 7(c)), perform cleaning (air blow & plasma cleaning), spraying (jet print), hardening (IR or UV or laser), engraving (laser patterning), sintering (laser), and inspection (refer to FIG. 7(d)), while continuously moving the panel 50, rotate the display panel 50 by 90 degrees, pre-align the display panel 50 again (refer to FIG. (refer to 7(f)), perform cleaning (air blow & plasma cleaning), spraying (jet print), hardening (IR or UV or laser), engraving (laser patterning), sintering (laser), and inspection (refer to FIG. 7(g)), while continuously moving the panel 50, and unloading the panel 50 (refer to FIG. 7(h)).

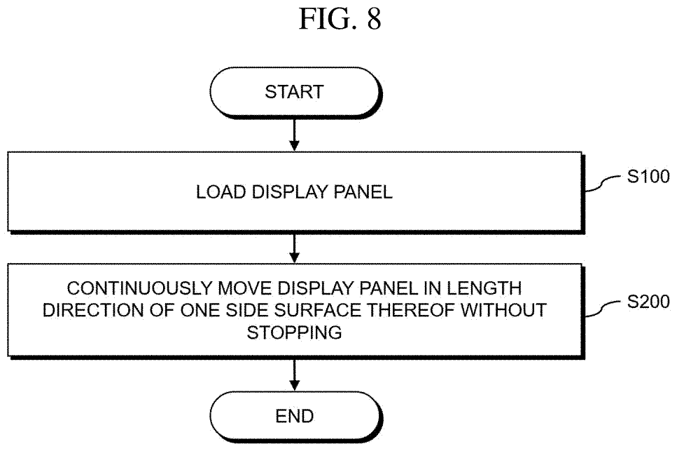

FIG. 8 is a flowchart illustrating a display panel electrode forming method according to an exemplary embodiment of the present invention.

As shown in FIG. 8, a method of forming the electrode 60 on at least one side surface of the display panel 50 in the display panel electrode forming apparatus 10 according to an exemplary embodiment of the present invention may include loading the display panel 50 (S100); and continuously moving the loaded display panel 50 not to stop in the length direction of one side surface of the display panel 50 (S200).

In the moving step (S200), a plurality of electrodes 60 may be formed by attaching the conductive paste 70 to the one side surface and hardening the conductive paste 70, engraving a portion of the conductive paste 70, and sintering.

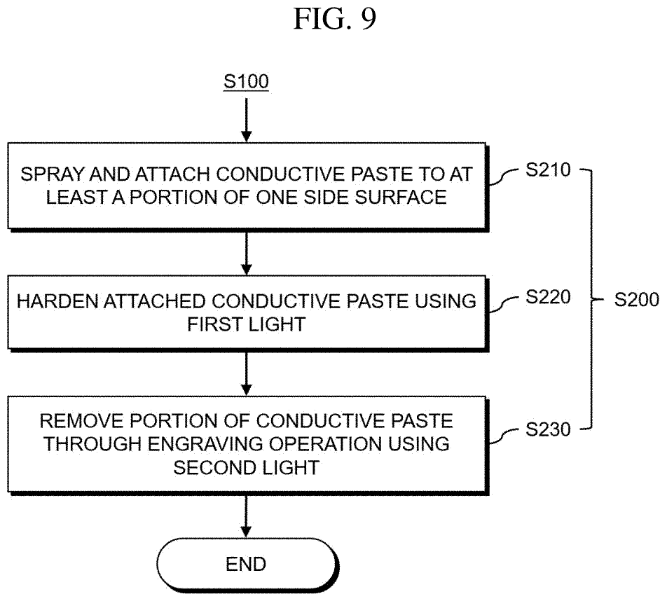

FIG. 9 is a flowchart illustrating a display panel electrode forming method according to an exemplary embodiment of the present invention.

As illustrated in FIG. 9, the moving step (S200) may include spraying and attaching the conductive paste 70 to at least a portion of the one side surface (S210); hardening the attached conductive paste 70 using a first light (S220); and removing a portion of the attached or hardened conductive paste 70 that does not correspond to the plurality of electrodes 60 through an engraving operation by using a second light (S230).

In an exemplary embodiment of the present invention, the method may further include re-hardening the attached conductive paste 70 using a third light (S240).

In the attaching step (S210), the conductive paste 70 may be continuously sprayed to a starting position and an ending position of the electrode 60, while the loaded display panel 50 continuously moves in the length direction of one side surface of the display panel 50 without stopping.

Alternatively, in another exemplary embodiment, in the attaching step (S210), the conductive paste 70 may be sprayed in units of the tabs 65. That is, spraying may not be performed in an empty section between each tab 65. In the present exemplary embodiment, the conductive paste 70 may be saved, and it is possible to minimize the particleization of the conductive paste 70 cut out in an engraving process to be described later and flying.

In an exemplary embodiment of the present invention, the removing step (S230) may be performed on the conductive paste 70 after the hardening (S220) is performed.

In an exemplary embodiment of the present invention, the re-hardening step (S240) may be performed on the conductive paste 70 after the removing step (S230) is performed.

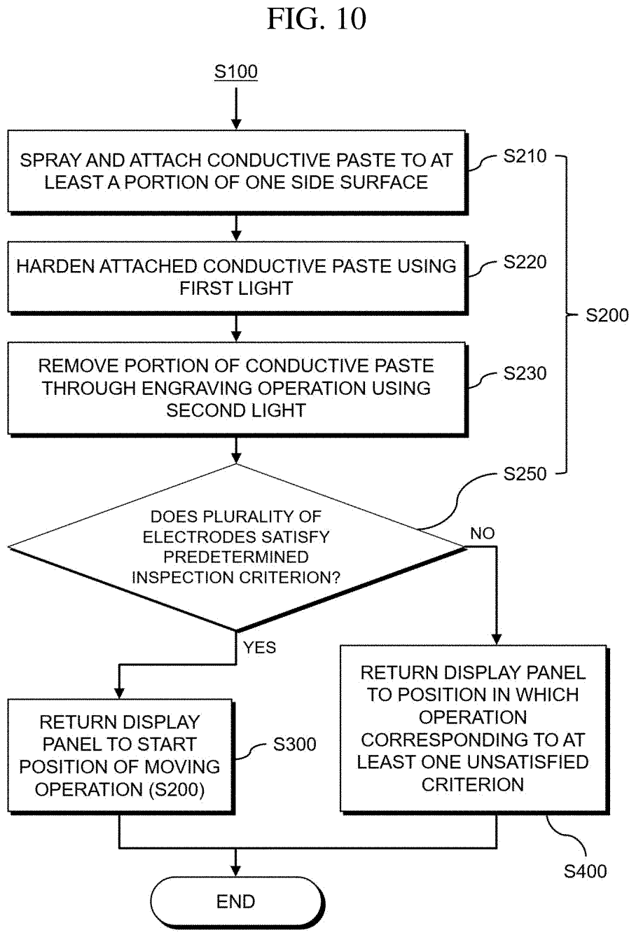

FIG. 10 is a flowchart illustrating a display panel electrode forming method according to an exemplary embodiment of the present invention.

As shown in FIG. 10, the moving step (S200) may further include determining whether the plurality of formed electrodes 60 satisfy a predetermined inspection criterion (S250).

In the determining step (S250), it is determined whether the plurality of electrodes 60 satisfy the predetermined inspection criterion through data analysis of an image obtained by photographing the plurality of formed electrodes 60 with at least one camera 610.

When the plurality of formed electrodes 60 satisfy a predetermined inspection criterion, the method may further include returning (S300) the display panel 50 to the starting position of the moving step (S200).

The returning step (S300) may include rotating (S310) the display panel 50 to form the electrode 60 on the other side surface vertically adjacent to the one side surface. That is, the display panel 50 may be rotated so that the other side surface comes to the position in which the one side surface was present.

The method may further include returning (S400) the display panel 50 to a position in which a step corresponding to the at least one criterion may be performed on one area including at least some of the electrodes 60 in the entire area of the one side surface, when at least some of the plurality of formed electrodes 60 do not satisfy at least one of the predetermined inspection criteria.

The predetermined inspection criterion may include a first criterion satisfied when the conductive paste 70 is not attached to an area except for the electrode 60 pattern in the entire area of the one side surface.

When the first criterion is not satisfied, the electrode 60 is not accurately formed in a predetermined pattern (shape), and the conductive paste 70 may remain in an area other than the predetermined pattern.

The step corresponding to the first criterion may be the removing step (S230). In extreme cases, a short circuit as shown in FIG. 5A may occur.

In this manner, when the first criterion is not satisfied, preferably, the display panel 50 is returned to a position corresponding to the removing step, and the conductive paste 70 remaining in the area other than the pattern is engraved and removed through rework.

The predetermined inspection criterion may include a second criterion satisfied when the conductive paste 70 is attached to the entirety of an area included in the electrode 60 pattern in the entire area of the one side surface.

The case in which the second criterion is not satisfied may be a case in which the conductive paste 70 does not completely fill the predetermined pattern. In this case, an open may occur as shown in FIG. 5B. In extreme cases, some of the electrodes 60 may be omitted. In this case, an electric signal is not transmitted from the electrode 60 to the lead 53.

The step corresponding to the second criterion may further include a removing step (S230), an attaching step (S210), and a hardening step (S220). According to an exemplary embodiment, a re-hardening (S240) may be further included.

In this manner, if the second criterion is not met, it is preferable to repeat the reattaching step (S210). In another exemplary embodiment, after removing the electrodes 60 included in a predetermined section (for example, the tab 65) including an abnormal electrode through an engraving operation, the step of reattaching to the corresponding section (S210), the hardening step (S220), the engraving step (S230) may be repeated, or according to an exemplary embodiment, the re-hardening step (S240) may be added to the three steps (S210 to S230) to repeatedly form the electrodes 60 again.

In the moving step (S200), the display panel 50 may be moved at a constant velocity in the length direction of the one side surface.

At least one of the attaching step (S210), the hardening step (S220), and the removing step (S230) may be performed, while the loaded display panel 50 is continuously moved in the length direction of the one side surface of the display panel 50 not to stop.

At least two of the attaching step (S210), the hardening step (S220), and the removing step (S230) may be simultaneously performed on the one display panel 50. That is, at least some of the time intervals in which at least two of the attaching operation, the hardening operation, and the removing operation are performed may overlap each other.

Each of the attaching step (S210), the hardening step (S220), the removing step (S230), and the hardening step (S240) may be performed, while the loaded display panel 50 is continuously moved not to stop in the length direction of the one side surface of the display panel 50, and another step may be performed again after one step is completed.

The display panel 50 electrode 60 forming method may be performed by a computer program.

The electrode forming method according to various exemplary embodiments of the present invention described above may be implemented as a computer program and provided to a server or devices in a state of being stored in various computer-readable non-transitory recording mediums. The computer program may be distributed by a distribution server.

The recording medium may be a non-transitory computer readable medium and the non-transitory computer readable medium is not a medium that stores data for a short time such as a register, a cache, a memory, or the like, but means a machine readable medium that semi-permanently stores data. Specifically, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like

Although the exemplary embodiments of the present invention have been illustrated and described hereinabove, the present invention is not limited to the specific exemplary embodiments described above, but may be variously modified by those skilled in the art to which the present invention pertains without departing from the scope and spirit of the present invention as claimed in the claims. These modifications should also be understood to fall within the technical spirit and scope of the present invention.

1. A method of forming an electrode on at least one side surface of a display panel in a display panel electrode forming apparatus, the method comprising:
loading the display panel; and
continuously moving the loaded display panel in a length direction of one side surface of the display panel without stopping,
wherein, in the moving, a conductive paste is attached to the one side surface and hardened, and a portion of the hardened conductive paste is engraved to form a plurality of electrodes.

2. The method of claim 1, wherein the moving includes:
spraying and attaching the conductive paste to at least a portion of the one side surface;
hardening the attached conductive paste using a first light; and
removing a portion of the hardened conductive paste through an engraving operation using a second light.

3. The method of claim 2, wherein the moving further includes re-hardening the conductive paste remaining after the portion is removed through the engraving operation using a third light.

4. The method of claim 2, wherein the moving further includes determining whether the plurality of formed electrodes satisfy a predetermined inspection criterion.

5. The method of claim 4, wherein the determining includes determining whether the plurality of electrodes satisfy the predetermined inspection criterion through data analysis of an image of the plurality of formed electrodes obtained with at least one camera.

6. The method of claim 4, further comprising:
returning the display panel to a starting position of the moving when the plurality of formed electrodes satisfy the predetermined inspection criterion,
wherein the returning includes rotating the display panel to form an electrode on another side surface vertically adjacent to the one side surface.

7. The method of claim 2, wherein the second light is a laser, and the plurality of electrodes includes a plurality of rectangular electrodes arranged in a line in the length direction.

8. The method of claim 1, wherein the moving includes moving the display panel at a constant velocity in the length direction of the one side surface.

9. A method of forming an electrode on at least one side surface of a display panel in a display panel electrode forming apparatus, the method comprising:
loading the display panel;
spraying and attaching a conductive paste to at least a portion of one side surface of the loaded display panel;
hardening the attached conductive paste using a first light; and
removing a portion of the hardened conductive paste through an engraving operation using a second light,
wherein at least one of the attaching, hardening, and removing is performed while the loaded display panel is continuously moved without stopping in a length direction of the one side surface of the display panel.

10. The method of claim 9, wherein the moving further includes determining whether a plurality of formed electrodes satisfy a predetermined inspection criterion.

11. The method of claim 10, further comprising:
returning the display panel to a starting position of the moving when the plurality of formed electrodes satisfy the predetermined inspection criterion,
wherein the returning includes rotating the display panel to form an electrode on another side surface of the display panel vertically adjacent to the one side surface.

12. The method of claim 9, wherein the moving includes moving the display panel at a constant velocity in the length direction of the one side surface.

13. A method of forming an electrode on at least one side surface of one display panel in a display panel electrode forming apparatus, the method comprising:
loading the one display panel;
spraying and attaching a conductive paste to at least a portion of one side surface of the one loaded display panel;
hardening the attached conductive paste using a first light; and
removing a portion of the hardened conductive paste through an engraving operation using a second light,
wherein at least some of time intervals during which each of at least two of the attaching operation, hardening operation, and removing operation overlap each other.

14. The method of claim 13, wherein at least two operations are performed while the loaded display panel is continuously moved without stopping in a length direction of the one side surface of the display panel.

15. The method of claim 14, wherein the at least two operations are performed while the display panel is moved at a constant velocity in the length direction of the one side surface.

16. The method of claim 13, further comprising determining whether the plurality of formed electrodes satisfy a predetermined inspection criterion.

17. The method of claim 15, further comprising:
returning the display panel to a starting position of the moving when the plurality of formed electrodes satisfy the predetermined inspection criterion,
wherein the returning includes rotating the display panel to form an electrode on another side surface of the display panel vertically adjacent to the one side surface.

18. A display panel electrode forming apparatus comprising:
a driving unit configured to load and move a display panel;
a spray unit configured to spray conductive paste;
a first photo-hardening unit configured to radiate a first light;
an engraving unit configured to radiate a second light; and
a controller configured to form a plurality of electrodes on one side surface of the display panel by controlling the driving unit, the spray unit, the first photo-hardening unit, and the engraving unit,
wherein the controller forms the plurality of electrodes by controlling the spray unit to continuously spray the conductive paste and attach to at least a portion of the one side surface, controlling the first photo-hardening unit to radiate the first light to harden the continuously sprayed conductive paste, and controlling the engraving unit to radiate the second light to remove a portion of the cured conductive paste through an engraving operation, while controlling the driving unit so that the loaded display panel is continuously moved in a length direction of the one side surface of the display panel, without stopping.

19. The display panel electrode forming apparatus of claim 18, further comprising:
a first inspection unit configured to form inspection data of the electrode,
wherein, while controlling the driving unit so that the loaded display panel is continuously moved in the length direction of one side surface of the display panel, without stopping, the controller controls the first inspection unit to form inspection data of the plurality of formed electrodes and determines whether the plurality of formed electrodes satisfy a predetermined inspection criterion by analyzing the inspection data.

20. The display panel electrode forming apparatus of claim 19, wherein
the first inspection unit includes at least one camera to form image data of the plurality of formed electrodes, and
the controller determines whether the plurality of formed electrodes satisfy a predetermined inspection criterion by analyzing the image data.

21. The display panel electrode forming apparatus of claim 18, further comprising:
an aligning unit configured to align a position and posture of the display panel before the spray unit sprays the conductive paste;
a cleaning unit configured to clean the one side surface before the conductive paste is sprayed from the spray unit, while the aligned display panel is continuously moving in the length direction of the one side surface of the display panel; and
a second inspection unit configured to acquire thickness information of the cured conductive paste.

22. The display panel electrode forming apparatus of claim 18, wherein the controller controls the driving unit so that the loaded display panel is moved at a constant velocity, while continuously moving in the length direction, without stopping.

23. The display panel electrode forming apparatus of claim 22, further comprising:
an aligning unit configured to align a position and a posture of the display panel before the loaded display panel is moved,
wherein, when the plurality of formed electrodes satisfy a predetermined inspection criterion, the controller controls the driving unit to rotate the display panel to form an electrode on another side surface of the display panel vertically adjacent to the one side surface.

24. The display panel electrode forming apparatus of claim 18, wherein the second light is a laser, and the plurality of electrodes includes a plurality of rectangular electrodes arranged in a line in the length direction.

25. (canceled)
